(19) United States
(12) Patent Application Publication
(10) Pub. No.: US 2007/0045260 A1
(43) Pub. Date: Mar. 1, 2007

(54) Welded aluminum sheets and process therefore

(76) Inventors: Frank Feng, Kingston (CA); William H. Christy, Kingston (CA)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/215,343

(22) Filed: Aug. 30, 2005

(51) Int. Cl. B23K 9/23

(52) U.S. Cl. 219/137 WM

(57) ABSTRACT

An edge of an aluminum 5xxx series sheet is welded to another aluminum 5xxx series sheet utilizing a low magnesium content aluminum alloy filler. The bottom weld seam metal is heat dressed as by a TIG and subsequently the bottom and the top, are planished to the same thickness as the sheets. Favorable properties such as the elimination of nail heads, improved corrosion resistance, and bendability are obtained.

### FIELD OF THE INVENTION

The present invention relates to welded aluminum articles, preferably sheets. Furthermore, the invention relates to a method including the steps of welding edges of at least two 5xxx series aluminum alloy sheets utilizing a 1xxx series aluminum alloy filler, dressing the bottom seam metal of the weld and planishing the weld seam.

### BACKGROUND OF THE INVENTION

Heretofore, work hardened 5xxx series aluminum alloy sheets have been butt welded utilizing a 5xxx series filler wire. However, in a welded condition, problems existed with regard to nail heads generally located on the top of the weld seam after a planishing operation and suitable bendability of the weld was generally not obtained due to stress risers. Poor corrosion resistance was also a problem.

U.S. Pat. No. 3,421,676 relates to an apparatus for joining metal products such as a plurality of metal sheets wherein the end portions of such sheets are held in adjoining relation and sprayed with a spray of finely divided hot molten metal particles which are allowed to cool and solidify. The solidified metal particles and the adjoining end portions of such sheets are then suitably heated to melt such solidified particles and join such end portions by reportedly providing a high-strength fused joint.

U.S. Pat. No. 6,440,583 relates to an aluminum alloy for a welded construction reportedly having excellent welding characteristics, which aluminum alloy comprises 1.5 to 5 wt % of Si (hereinafter, wt % is referred to as %), 0.2 to 1.5% of Mg, 0.2 to 1.5% of Zn, 0.2 to 2% of Cu, 0.1 to 1.5% of Fe, and at least one member selected from the group consisting of 0.01 to 1.0% of Mn, 0.01 to 0.2% of Cr, 0.01 to 0.2% of Ti, 0.01 to 0.2% of Zr, and 0.01 to 0.2% of V, with the balance being aluminum and inevitable impurities. Also disclosed is a welded joint having this aluminum alloy base metal welded with an Al—Mg- or Al—Si-series filler metal.

U.S. Pat. No. 6,579,386 relates to a weld filler wire chemistry for fusion welding 2195 aluminum-lithium. The weld filler wire chemistry is an aluminum-copper based alloy containing high additions of titanium and zirconium. The additions of titanium and zirconium supposedly reduce the crack susceptibility of aluminum alloy welds.

An article by I. J. Polmear and D. R. Wilkinson, Final Report on Effects of TIG Dressing on the Fatigue Properties of Aluminum Alloy Butt and Fillet-Welded Plates—AWRA Report P3-1 7-81 (1981), relates to a study of the fatigue behavior of 5083 aluminum alloy plates containing transverse butt- and fillet-welds which supposedly shows that TIG dressing on the toe regions of welds may increase average lives by factors ranging from two to five times. Such effect supposedly can be correlated directly to a reduction in the notch effect at weld toes due to the dressing operation.

An article by I J Polmear, Post-Weld Surface Treatments To Improve Fatigue Properties of Aluminum Weldments—AWRA Document P3-11-85 (1985), reports that laboratory tests have supposedly shown that needle peening the toe regions of fillet welds can cause a significant improvement in the fatigue performance of aluminum alloy fillet welds. This effect is reportedly most marked if peening is carried out after the application of any preload. Field trials carried out over periods of eight years on welded aluminum wagons operating on Queensland and New South Wales Railways, have supposedly confirmed the beneficial effects of peening. An alternative method of improving fatigue performance by TIG dressing of weld toes has supposedly proved even more effective in laboratory tests. However, such a technique has yet to be tested in field trials.

Specifications for wrought aluminum alloys are listed in the April 2004 Aluminum Association publication entitled: “International Alloy Designations and Chemical Composition Limits for Wrought Aluminum and Wrought Aluminum Alloys”.

### SUMMARY OF THE INVENTION

Aluminum alloy articles, preferably sheets, of the 5xxx series are butt welded utilizing a 1xxx series aluminum alloy filler. The weld drop-through is dressed by any desirable treatment such as TIG and both sides of the weld seam are then planished as by bead rolling to match the thickness of the sheets. The welded seam contains low amounts of magnesium such as from about 1.0% to about 3.5% by weight and preferably from about 1.8% to about 3.5% by weight of the total weld composition.

### DETAILED DESCRIPTION OF THE INVENTION

The aluminum alloy articles, for example, but not limited to, sheets, plates, pieces, or the like that are welded together comprise one or more work hardened 5xxx series alloy sheets according to the Aluminum Association Designations for Wrought Aluminum Alloys. Such aluminum alloys contain magnesium as the primary alloying element and may contain from about 0.2% to about 5.6% and desirably from about 2.2% to about 5.0% by weight thereof based upon the average magnesium content of the sheets to be welded. The total amount of alloying elements, other than aluminum, but including magnesium, is generally from about 3.5% to about 8.0% by weight based upon the total weight of the 5xxx aluminum articles. Exemplary alloys include 5052, 5082, 5083, 5086, 5087, 5182, 5186, 5283, 5383, 5454, 5554, 5654, and 5754 with preferred alloys including 5052, 5083, 5086, 5087, 5186, 5283, 5383, 5454, and 5754. The thickness of the articles can vary and generally falls within a range of from about 1.5 mm to 25 mm. Although the articles that are welded together can be different, preferably they are of the same alloy. The two or more alloy sheets are preferably butt welded together according to conventional methods and manners known to the art and to the literature such as utilizing gas metal arc welding (GMAW), also known as MIG welding.

During the welding process, the weld metal generally forms a convex bead along the upper surface of the joint or weld which is formed by the intermixing in the moltent state, of the metal filler and sheet alloy. The metal that drops through the joint is caught by a grooved backing bar supporting the bottom of the seam. This weld drop-through, according to the concepts of the present invention, is dressed by reheating the bottom seam metal portion to a melting temperature as by applying an arc, e.g. tungsten-inert gas (TIG dressed), or plasma. The dressing process has been found to improve the weld drop-through profile by yielding a smoother surface; eliminating welding defects at the root such as lack of penetration and/or oxide inclusion, surface voids, and profile discontinuities; and improving a weld joint reverse bendability. Preferably only the bottom weld portion is dressed, but optionally the top weld portion can also be dressed (not preferred).

The weld seam, after dressing, is preferably planished (rolled flat) to substantially the same thickness as that of the adjacent aluminum alloy sheets. Planishing machines and methods are known to the art and to the literature.

However, during welding of aluminum alloys, welds are often produced with cold overflow which produces a nail-head effect. Planishing of the prior art weld will press the nail-head into the bulk metal in the weld toe area as a crack. Upon the application of various strains and/or stresses, the cracks will tend to propagate.

An important aspect of the present invention is the utilization of a 1xxx series aluminum alloy filler with very little or even no magnesium. Any form of 1xxx series aluminum alloy filler can be used, including but not limited to, wire, powder, compacted powder, particles, preshaped inserts, and the like with wire being preferred. That is, while preferably no or zero magnesium is contained in the 1xxx aluminum alloy filler, the amount therein can be equal to or less than 0.2% by weight, and desirably equal to or less than 0.1% by weight, based upon the total weight of the aluminum alloy filler composition. Examples of 1xxx series filler wire include, but are not limited to, 1100, and 1188. 1100 series filler wire is preferred.

It has been found that by utilizing one or more aluminum alloy fillers of the 1xxx series in lieu of traditional heretofore utilized 5xxx series filler wire alloys, which have magnesium levels very similar to the 5xxx series sheet set forth herein above, several unexpected advantages occur, after dressing the bottom weld portion and planishing the top and bottom weld surfaces, including elimination of nail-head in the top convex portion of the weld seam, improved bendability, and improved corrosion resistance. Such improved properties are obtained when the amount of magnesium in the 5xxx aluminum sheets preferably ranges from about 2.2% to about 5.0% by weight. The improved properties are thought to occur because of the reduced level of magnesium in the weld portion or area, which is generally homogeneous with respect to the various metals therein. It has been found that the magnesium level in the weld ranges from about 1.0% to about 3.5% and preferably from about 1.8% to about 3.5% by weight based upon the total weight of the weld composition. If the magnesium level is above 3.5%, unacceptable corrosion can occur if the welded sheets are “sensitized” by being exposed to certain high temperature conditions during use. Of course, if 5xxx aluminum sheets are utilized having lower or higher magnesium content than indicated above, the weld area correspondingly will have a lower or higher magnesium level such as from about 0.4% to about 4.8%. In contrast, for the same 5xxx series aluminum sheet, the magnesium content of the weld is always higher when utilizing a 5xxx series filler wire weld alloy than it is when utilizing a 1xxx series filler wire alloy. Stated differently, the weld compositions of the present invention contain substantially less magnesium than weld compositions utilizing traditional 5xxx series filler wire alloys.

An important advantage of the present invention is that after the bottom weld portion is dressed and both sides of the weld bead are planished, the yield strength is essentially the same or greater than the yield strength of the work hardened 5xxx series aluminum alloy article utilized; for example, from about the same, i.e. about zero, to an increase of about 25% in yield strength. In stark contrast thereto, there is approximately a 30% drop in the yield strength of. the weld joint in a welded condition without bead planishing.

In one embodiment, a preferred process of preparing welded aluminum alloy sheets is as follows. While the process is described with respect to AA 5083 alloy sheets and AA100 filler wire, it is to be understood that other 5xxx series alloys or 1xxx filler wire can be used in the process. A work hardened AA 5083 alloy sheet having a thickness of from about 3 mm to about 10 mm with a preferred range from about 5 mm to about 6 mm was utilized. A grooved copper backing bar was utilized having a groove depth of from about 0.254 mm to about 1.27 mm and a preferred depth of from about 0.38 mm to about 0.635 mm. The groove width was generally from about 3 mm to about 10 mm and preferably from about 5 mm to about 8 mm.

Generally standard or typical GMAW welding conditions were utilized for arc welding a 5 mm 5083 aluminum alloy sheet. The conditions with regard to the control wherein the filler wire was 5356 welding alloy and the present invention wherein the filler wire was 1100 welding alloy are set forth in Table 1.

TABLE 1

| | | |
|---|---|---|
| Condition | 5356 Filler Wire | 1100 Filler Wire |

| Shielding gas | Argon at 50 cfh | | Argon at 50 cfh | |
|---|---|---|---|---|
| Wire diameter | 1.2 | mm | 1.2 | mm |
| Wire speed | 545 | in/min | 400 | in/min |
| Torch angle | 20 | degrees | 20 | degrees |
| Welding speed | 40 | in/min | 40 | in/min |
| Welding current | 260 | amps | 270 | amps |
| Welding voltage | 24 | volts | 23 | volts |

Since an important aspect of the present invention is to dress only the bottom or weld drop-through portion of the weld, a TIG dressing was used to blend the root (drop-through) of the weld to modify the square edge thereof into a smooth sloping transition to the surface of the aluminum alloy sheet. TIG dressing is well known to the literature and to the art and generally involves utilizing a tungsten inert gas heated by an electric arc, commonly referred to as a TIG torch, to heat the weld portion to smooth the surfaces thereof. Often due to the large size of the adjacent 5xxx series aluminum sheets which are difficult to rotate 180° to expose the bottom weld portion which can then be TIG dressed, the TIG torch is merely placed under the weld, i.e. inverted, to dress the same. The dressing procedure parameters are set forth in Table II.

TABLE II

| | Electrode | | Travel | Electrode | | Shield Ar | |
|---|---|---|---|---|---|---|---|
| | dia | Current | Speed | Stand-off | Cleaning | Rate | Electrode |
| | (inch) | (A) | (in/min) | (in) | Ratio | (cfh) | type |
| Workable | 3/16 to | 250 to | 30 to 50 | 1/32 to | 1.0 to | 40 to 60 | Pure |
| Range | ¼ | 300 | | 3/32 | 2.0 | | tungsten or |
| | | | | | | | 2% thoriated |
| Preferred | ¼ | 300 | 40 | 1/16 | 1.5 | 50 | 2% thoriated |
| Range | | | | | | | |

Table II is self-explanatory and the cleaning ratio relates to the relative amount of current flowing from the weld tip to the work piece versus current flowing back from the work piece to the tip. Inasmuch as the ratio of 2 indicates a balanced condition, a cleaning ratio below 2 means that the cleaning component is greater than the welding component.

After dressing, the weld was planished or bead rolled on both the top and bottom surfaces in accordance with the following parameters set forth in Table Ill. Planishing is carried out at ambient temperatures such as from about 15° C. to about 40° C. and introduces work hardening into the weld. While work hardening can be introduced at higher temperatures, the amount thereof is reduced and can even be nil.

TABLE III

| | | | | Bead Rolling | |
|---|---|---|---|---|---|
| | Number of | Roll Dia. | Roll Width | Speed | Temperature |
| | Passes | (inch) | (inch) | (in/min) | (C. °) |
| Workable | 1˜5 | 3˜10 | 1.5˜10 | 20˜150 | ambient |
| Range | | | | | |
| Preferred | 1 | 4˜6 | 2˜5 | 40˜100 | ambient |
| Range | | | | | |

After planishing, samples of the weld were taken and analyzed with regard to their composition. Inasmuch as the weld area is generally a homogeneous composition with very little or minute magnesium gradients existing, a sample can be taken from any portion of the weld area. Generally a fairly large portion of the weld area such as about 30% is taken and analyzed with respect to the various metals therein. The results are set forth in Table IV wherein the contents of the weld sample are listed with respect to utilizing an 1100 filler wire and, as a control, a 5356 filler wire. Such weld samples were obtained utilizing filler wire 1100 weld alloy with respect to a smaller dilution (1100 S—72% dilution rate) and a larger dilution (1100 L—75% dilution rate). These dilutions which represent the percent of base metal (sheet alloy) in the weld metal, are dependent on wire speed, welding power and other parameters. The weld sample obtained utilizing 5356 weld alloy as a filler wire was also sampled in a similar manner. In both cases, the sheets were 5083 aluminum alloy sheet, the edges of which were welded together.

TABLE IV

| | Weld Sample | | | | | | | | |
|---|---|---|---|---|---|---|---|---|---|
| | Cr | Cu | Fe | Mg | Mn | Ni | Si | Ti | V |
| 1100 S | 0.067 | 0.041 | 0.31 | 3.12 | 0.42 | 0.010 | 0.082 | 0.011 | 0.010 |
| filler wire | | | | | | | | | |
| 1100 L | 0.067 | 0.054 | 0.28 | 3.24 | 0.43 | 0.005 | 1.26 | 0.010 | 0.009 |
| filler wire | | | | | | | | | |
| 5356 (Control) | 0.079 | 0.021 | 0.20 | 4.42 | 0.41 | 0.004 | 0.074 | 0.031 | 0.010 |
| filler wire | | | | | | | | | |
| 5083 sheet | 0.089 | 0.033 | 0.26 | 4.33 | 0.57 | 0.005 | 0.082 | 0.007 | 0.009 |

When the 5083 sheets were welded with the 5356 filler wire, the amount of magnesium increased from 4.33% to 4.42% by weight based upon the total weight of the weld. In contrast, when the 1100 filler wire of the present invention was utilized which contained no magnesium, the magnesium content of the weld was only 3.12% and 3.24% by weight.

The weld of the present invention and the control weld were tested with respect to tensile strength (ultimate tensile strength and yield strength), welding factor, a bend test and a corrosion test and the results thereof are set forth in Table V. As noted above, testing occurred after the bottom of the welded area was TIG dressed and both weld surfaces were planished. Since the compositions of 1xxx series filler wire are very similar, and contain a high amount of aluminum therein, generally very similar properties will be obtained when different 1xxx filler wires are utilized.

TABLE V

| | | | | | NAMLT Corrosion Test | |
|---|---|---|---|---|---|---|
| | | | Welding | | of Weld Bead* | |
| | Tensile Test | | Factor | Bend Test | | 150° C. × |
| Sample | UTS | 0.2% YS | (YS_{weld}/ | (32 mm Dia. | | 1 week |
| Tested | (MPa) | (MPa) | YS_{parent sheet}) | Mandrel) | As is | exposure |
| Control | 302 | 169 | 0.69 | passed | passed | mixed** |
| 5356 Filler | | | | | | |
| Wire- | | | | | | |
| as welded | | | | | | |
| Control | 340-355 | 250-280 | >1 | failed | passed | mixed |
| 5356 Filler | | | | | | |
| Wire- | | | | | | |
| planished | | | | | | |
| Invention | 320-350 | 240-280 | >1 | passed | passed | passed |
| 1100 Filler | | | | | | |
| Wire- | | | | | | |
| planished | | | | | | |
| Parent Sheet | 347 | 245 | — | passed | passed | failed |
| Metal | | | | | | |
| 5083 H116 | | | | | | |

*Actual measurements were done on weld bead thickness reduction based on which the rate of attack was calculated, before being converted to weight loss.
**Mixture of passed and failed - results were marginal.

The weld tensile tests were conducted in accordance with ASTM B557. The bend test was in accordance with ANSI/AWS D1.2-2003 “Structural Welding Code—Aluminum”, whereas the corrosion test was in accordance with Gravimetric NAMLT Test—ASTM G67-99 “Standard Test Method for Determining the Susceptibility to Intergranular Corrosion of 5xxx Series Aluminum Alloys by Mass Loss After Exposure to Nitric Acid”.

The control weld utilized a 5356 filler wire whereas the modified weld of the present invention utilized a 1100 filler wire, both in association with 5083 H116 aluminum alloy sheets. The tensile and yield strength of the planished welds formed from both filler wires were similar and were generally close to the respective values for the parent sheet metal. In contrast, the tensile values for the unplanished control welds were substantially lower than those of the parent sheet. The root bend samples of the present invention exhibited a rounded arc and deformed uniformly around the mandrel whereas the control had stress risers and thus generally formed an apex. The formation of the nail-heads was eliminated with the present invention due to the use of the 1100 filler wire and dressing the bottom weld whereas the control contained nail-heads. These are important properties inasmuch as welded aluminum alloy sheets which do not pass the bend test are generally not commercially viable.

Corrosion resistance is another important commercial property. While the controls passed the Gravimetric NAMLT Test, this is only so because it was performed at ambient temperature. At higher temperatures, the controls are marginal. More specifically, aluminum alloys containing a high percentage of magnesium may be susceptible to intergranular corrosion attack (IGA). If the magnesium is retained in solid solution or partially precipitated as intermetallic particles dispersed uniformly throughout the matrix, the alloys will normally be corrosion resistant. Wrought aluminum alloys containing less than 3.5% magnesium are generally considered immune to IGA even if a sensitization treatment (such as high temperatures of 120° C. to 150° C.×1 wk) is given to the material intentionally to create a condition that will tend to cause the particles to precipitate along the grain boundaries. If an alloy containing magnesium above 3.5% is exposed to a service condition similar to the one mentioned above, it will likely become sensitive to IGA. Similarly, for a 5xxx alloy with a cast microstructure such as that exhibited by fusion welds, a critical value on magnesium content also exists, and laboratory research results have indicated that this threshold below which the alloy will not be IGA sensitive, is about 3.5%.

A commercially available marine grade 5xxx wrought aluminum alloy containing more than about 3.5% magnesium should initially be resistant to IGA or intergranular stress corrosion cracking (IGSCC), but this will not prevent it from becoming susceptible to these corrosion effects if the alloy is exposed to temperatures ranging from 50° C. to 200° C. for a sufficiently long period of time during service.

### Alternative Embodiment

An alternative embodiment of the present invention relates to the utilization of various aluminum alloy fillers that have a magnesium content of less than 2.4% by weight, preferably less than 1.0% by weight and most preferably less than 0.5% by weight to weld 5xxx aluminum series sheets together. Any aluminum alloy with the right level of magnesium can be used as a filler in the form of e.g. powders, particles, preshaped inserts, or wire. However, some aluminum alloy series fillers may contain other components in significant amounts that may produce undesirable effects in areas other than weldability. The desired properties are: elimination of nail-head, improved bendability, improved corrosion resistance, and improved yield strength. Alloys of the 1xxx or low mangnesium content 5xxx families are preferred.

The magnesium content of the 5xxx aluminum series sheets are the same as hereinabove and thus contain from about 0.2 to about 5.6% by weight and desirably from about 2.2 to about 5.0% by weight of magnesium therein, and can be welded in the same manner or method as set forth herein with respect to planishing, heat dressing, and the like. Similarly, the magnesium content of the weld is the same as set forth hereinabove and thus contains from about 1.0% to about 3.5% by weight, preferably from about 1.8% to about 3.5% by weight of magnesium therein. Otherwise the desired properties are not obtained.

While in accordance with the Patent Statutes, the best mode and preferred embodiments have been set forth, the scope of the invention is not limited thereto, but rather by the scope of the attached claims.

What is claimed is:

1. A welded aluminum alloy article, comprising:
at least two aluminum alloy 5xxx series sheets butt welded together by at least one 1xxx series aluminum alloy filler containing about 0.2% or less by weight of magnesium.

2. The welded aluminum alloy article according to claim 1, wherein said 1xxx series aluminum alloy filler wire contains 0.1 % by weight or less of magnesium, wherein the top and bottom surfaces of said butt weld are planished, wherein said bottom portion of said weld is heat dressed, and wherein said weld contains from about 1.0% to about 3.5% by weight of magnesium.

3. The welded aluminum alloy article according to claim 2, wherein said weld contains from about 2.5% to about 3.5% by weight of magnesium, and wherein said 5xxx series sheet is 5052, 5082, 5083, 5086, 5087, 5182, 5186, 5283, 5383, 5454, 5552, 5554, 5654, or 5754, or combinations thereof.

4. The welded aluminum alloy article according to claim 3, wherein said heat dressed weld portion is tungsten inert gas dressed, wherein said weld contains from about 1.8% to about 3.5% magnesium by weight, wherein said filler wire is 1100 or 1188, or combinations thereof, and wherein said aluminum alloy sheet is 5052, 5083, 5086, 5087, 5186, 5283, 5383, 5454, or 5754, or combinations thereof.

5. The welded aluminum alloy article according to claim 1, wherein said aluminum alloy 5xxx series sheets have an average magnesium content of from about 0.2% to about 5.6% by weight.

6. The welded aluminum alloy article according to claim 4, wherein said aluminum alloy 5xxx series sheets have an average magnesium content of from about 2.2% to about 5.0% by weight.

7. An aluminum weld composition for securing at least two aluminum alloy articles together, comprising:
said aluminum weld composition derived from at least one 1xxx series aluminum alloy filler in the presence of an aluminum alloy 5xxx series article, and wherein said filler contains about 0.2% or less by weight of magnesium.

8. The aluminum weld composition according to claim 7, wherein said weld composition contains from about 1.0% to about 3.5% by weight of magnesium, and wherein the bottom portion of said weld composition is heat dressed.

9. The aluminum weld composition according to claim 8, wherein said top and bottom portions of said weld compositions are planished, wherein said weld composition contains from about 1.8% to about 3.5% by weight of magnesium.

10. The aluminum weld composition according to claim 9, wherein said lxxx series filler wire is 1100 or 11 88, or combinations thereof, and wherein said 5xxx series aluminum alloy sheet is 5052, 5083, 5086, 5087, 5186, 5283, 5383, 5454, or 5754, or combinations thereof.

11. A process for welding aluminum alloy sheets, comprising the steps of:
welding at least one aluminum alloy 5xxx series sheet to at least one other aluminum alloy 5xxx series sheet utilizing an aluminum alloy 1xxx series filler and forming a weld, said filler containing about 0.2% or less by weight of magnesium, and heat dressing the bottom of said weld.

12. The process according to claim 11, including planishing both sides of said weld including said heat dressed portion, and wherein said weld contains from about 1.0% to about 3.5% by weight of magnesium.

13. The process according to claim 12, wherein said filler is a wire containing about 0.1 % or less by weight of magnesium, wherein said weld contains from about 1.8% to about 3.5% magnesium, and wherein said aluminum alloy 5xxx series sheet is 5052, 5083, 5086, 5087, 5186, 5283, 5383, 5454, or 5754, or combinations thereof.

14. The process according to claim 13, wherein said heat dressing utilizes a tungsten inert gas.

15. A welded aluminum alloy article, comprising:
at least two 5xxx series sheets welded together by an aluminum alloy filler;
a weld formed by the intermixing in the molten state of the filler and sheet alloys;
said aluminum alloy weld filler containing less than 2.4% by weight of magnesium; and
wherein the amount of magnesium in said weld is from about 1.0% to about 3.5% by weight.

16. The welded aluminum article according to claim 15, wherein said filler is composed of a 1xxx or 5xxx alloy.

17. The welded aluminum alloy article according to claim 15, wherein each said sheet, independently, contains from about 0.2% to about 5.6% by weight of magnesium and said filler contains less than 1.0% by weight magnesium.

18. The welded aluminum alloy article according to claim 17, wherein the top and bottom surfaces of said weld are planished, wherein the bottom portion of said weld is heat dressed, and wherein said filler contains about 0.5%% by weight or less of magnesium.

19. The welded aluminum alloy article according to claim 18, wherein said heat treated weld portions are tungsten inert gas dressed, and wherein said weld contains from about 1.8% to about 3.5% by weight of magnesium.

20. The welded aluminum alloy article according to claim 15, wherein said aluminum alloy weld filler is a wire.

21. The welded aluminum alloy article according to claim 19, wherein said aluminum alloy weld filler is a wire.

22. A process for welding aluminum alloy sheets, comprising welding at least one aluminum alloy 5xxx series sheet to at least one other aluminum alloy 5xxx series sheet by employing an aluminum alloy filler to form a weld, said filler containing less than 2.4% by weight magnesium and said weld containing from about 1.0 to about 3.5% by weight of magnesium.

23. The process according to claim 22, including planishing both sides of said weld and heat dressing the bottom of said weld.
